(19) United States
(12) Patent Application Publication
(10) Pub. No.: US 2009/0296704 A1
(43) Pub. Date: Dec. 3, 2009

(54) METHOD FOR MULTI-PATH SOURCE ROUTING IN SENSOR NETWORK

(75) Inventors: Joungsik KIM, Daegu (KR); Gwangsu KIM, Daejeon-city (KR); Kyuhyung KIM, Daegu (KR); Sutaek OH, Kyungsangnam-do (KR); Hongjong JEONG, Daegu (KR); Hyunwoo KANG, Daegu (KR); Dongkyun KIM, Daegu (KR)

Correspondence Address: STAAS & HALSEY LLP, SUITE 700, 1201 NEW YORK AVENUE, N.W., WASHINGTON, DC, 20005, US

(73) Assignees: Electronics and Telecommunications Research Institute, Daejeon-city (KR); Kyungpook National University Industry-Academic Cooperation Foundation, Daegu (KR)

(21) Appl. No.: 12/325,061

(22) Filed: Nov. 28, 2008

(30) Foreign Application Priority Data
May 30, 2008 (KR) 10-2008-0051225

(51) Int. Cl. H04L 12/56

(52) U.S. Cl. 370/389

(57) ABSTRACT

A method for a multi-path source routing in a sensor network. In the sensor network including a sink node and a plurality of sensor nodes, the sensor network transmits data packets through a downlink route set based on a routing table generated by collecting uplink neighbor information of each sensor node from a control message for initializing a network and an uplink route formed by using uplink neighbors of each sensor node. Uplink neighbors for transmitting data from each sensor node to the sink node by performing a network initialization process and acquires the information in the sink node to generate the multi-path is maintained. As a result, it has advantages of reducing a control message overhead while using the multi-path and increasing scalability and energy efficiency by keeping a routing table small in the sensor node regardless of the size of the network.

### RELATED APPLICATIONS

The present application claims priority to Korean Patent Application Serial Number 10-2008-0051225, filed on May 30, 2008, the entirety of which is hereby incorporated by reference.

### BACKGROUND OF THE INVENTION

1. Field of the Invention

The present invention relates to a method for a MULTI-path source routing in a sensor network, and in particular, to a method for setting a multi-path in a sensor network and a method for recovering a disconnected route.

This work was supported by the IT R&D program of MIC/IITA [2007-Giban-10, Establishment and Operation of Embedded S/W Technology Supporting Center at Daegu].

2. Description of the Related Art

Generally, a wireless sensor network is provided with a large number of sensor nodes for monitoring a wide field, wherein the sensor nodes are intensively disposed to continuously perform functions of the network even if a small number of sensor nodes are in an inoperable state, due to battery exhaustion, etc. The arrangement of sink nodes is limited and there are many cases where most sensor nodes have sink nodes that do not exist within their transmission range. Because of the characteristics of the sensor nodes, a need exists for a wireless multi-hop routing that cooperates between nodes as in a wireless multi hop network, such as a mobile Ad hoc network or a mesh network.

In the wireless sensor network of the related art, the routing method is largely sorted into a data based routing method and an address based routing method. At this time, the sorting is on the basis of which one is selected as the sorting criterion.

First, describing the data based routing method, the sink node basically broadcasts data that it wants to collect to a network in the form of an interest data message and the sensor nodes listening to the data sets a reverse route to the sink node. The sensor node that collects and receives data meeting request conditions of the sink node transmits data to the sink node through the reverse route. During the above-mentioned process, an intermediate sensor node receives several similar data, performs fusion thereof, and transmits the fused data.

The most widely known data based routing protocols is a directed diffusion. In the directed diffusion, the sensor node listening to the interest data message transmits the collected data to the sink node through the reverse route set while broadcasting the interest data message. Since the initially set reverse route is set by broadcasting, there can be several routes arriving at the sink node. The sink node reduces several routes to one route and selects neighboring sink nodes transmitting the interest data according to a specific metric such as signal intensity in order to receive the interest data at a higher period to transmit a route reinforcement message. The intermediate sensor node receiving the route reinforcement message also selects neighboring intermediate sensor nodes transmitting the interest data to transmit the reinforcement message. If the reinforcement message arrives up to a node that collects data, the corresponding node transmits the collected data at a higher period along a single route that is configured by the reinforcement message.

In order to ensure the fault tolerant of the network, a highly-resilient and an energy-efficient multi-path routing as the directed diffusion extending form are used. Instead of transmitting the route reinforcement message used in the directed diffusion to one neighboring node, this transmits the route reinforcement message to several neighboring nodes to configure the multi-path. However, since a method for searching a node-disjoint route configured of completely different nodes degrades energy efficiency, even if the method shares the same nodes, it uses a braided route having the number of shorter hops.

In an energy aware routing, which is the address based routing protocol, uses the multi-path routing that can minimize energy consumption to extend the duration time of the network. A method for stochastically selecting the multi-path is used based on a residual energy amount. The method is useful for increasing the network duration time if there is a large amount of residual energy even when the route is not optimal. However, since the protocol uses an on-demand route discovery method that allows the designation node to broadcast a request message to the entire network each time a route is needed, there is a control message overhead in a route setting.

In a DMPR, a colored tree based method for searching two multi-paths that are constituted by a non-overlapped node in order to communicate one sensor node with two different sink nodes in a network having several sinks represented by a drain, is used. In this method, since a size of the routing table is large in proportion to the number of the sink nodes, it has an advantage of ensuring scalability, but a disadvantage in that the overhead used for configuring the route is large, the configured route is not the shortest route, and the entire colored tree for recovering the route should be reconfigured.

Meanwhile, in addition to the wireless sensor network routing method, routing methods for increasing the fault tolerant and energy efficiency by providing the multi-path in the mobile Ad hoc network having the environment similar to the wireless sensor network are proposed.

Among others, a multi-path dynamic source routing (hereinafter, referred to as MDSR) is an extension protocol that can support the multi-path by modifying a route searching process and a route maintenance process of a dynamic source routing (DSR). The on-demand routing protocol such as the DSR broadcasts a route request (RREQ) message to the network when the source node communicates with other nodes. The route request message reaches the designation node using different routes and the DSR replies to only the first reached route request message. However, the MDSR configures a main route using the first reached route request message and then uses an alternate route by selecting a route configured of different nodes among the next reached messages. If the main route is lost, it prevents the control message for searching a new route from broadcasting to the entire network by transmitting packets through the alternate route.

The multi-path source routing (hereinafter, referred to as MSR) uses a basic concept of the MDSR and uniformly distributes loads to the network by additionally measuring a round trip time.

The MSDR or the MSR can significantly reduce the control message overhead generated when the route is disconnected, but when the MSDR or the MSR is applied to the sensor network, the route search should be tried by the number of sensor nodes in order to communicate the sink nodes with other sensor nodes. The route search broadcasts the control message to the entire network, thereby generating a very large overhead. Further, since the intermediate sensor node should maintain a route cache that stores an alternate route in order to prevent a packet loss when a main route to the specific designation is disconnected, which increases the overhead for maintaining the control message overhead or the route cache when communication between the sensor nodes is required, it is not suitable for the sensor network.

Therefore, a need exists for solving a scalability problem of a routing method in terms of the control message overhead and the routing table size in the wireless sensor network, the fault tolerant problems so as not to affect errors of some nodes on all of the routing processes, a route setting problem of a data traffic pattern between the sensor node and the sink node, and a problem of simplifying in order to easily implement in the sensor node having a low processing capacity.

### SUMMARY OF THE INVENTION

The present invention proposes to solve the above problems. It is an object the present invention to provide a tree-based multi-path source routing method that can solve network scalability, fault tolerant, and simplification of optimal route setting and implementation, which are the main problems of a sensor network.

Further, it is another object of the present invention to provide a multi-path source routing method of a wireless sensor network that lowers a control message overhead required for a route setting in a sensor network and removes a routing table overhead of the sensor node to increase scalability and energy efficiency.

Also, it is still another object of the present invention to provide a routing method of a wireless sensor network to increase fault tolerant by providing a multi-path that facilitates a route setting and recovery.

In order to achieve the above object, there is provided a multi-path source routing method in a sensor network including sink nodes and a plurality of sensor nodes comprising: allowing the sink node to transmit a control message for initialization to each sensor node and to receive a list of uplink neighbors generated from each sensor node based on information on neighboring nodes obtained from the control message; allowing the sink node to generate a routing table for each sensor node from a list the uplink neighbors received while receiving the list of the uplink neighbors; when the sink node intends to transmit a data packet to a designation node, allowing the sink node to search a route up to the designation node using the routing table; and transmitting the data packet to the designation node along a route up to the designation node searched in the searching the route.

The control message is a network initialization request message that includes at least one of a sequence number generating the control message, a hop count until the control message is transmitted from the sink node to each sensor node, an address of the sink node, and an address of a neighboring node transmitting the control message.

When generating the list of the uplink neighbors from each sensor node, if the corresponding sensor node receives at least two control messages, it includes comparing the sequence numbers included in the control message, wherein the corresponding sensor node sets the neighbor node transmitting the latest control message having a large sequence number to the uplink neighbor to generate the list of the uplink neighbors. Further, when generating the list of the uplink neighbors from each sensor node, if the corresponding sensor node receives the control messages from at least two neighbor nodes, it includes comparing the hop counts included in the control message, wherein the corresponding sensor node sets the neighbor node transmitting the control message having a small number of hop counts to the uplink neighbor to generate the list of the uplink neighbors.

Also, the multi-path source routing method in the sensor network according to the present invention further comprises allowing the corresponding sensor node to change the address of the neighbor node transmitting the control message to its own address, to increase the hop count by “1”, and to transmit the increased hop count to another neighbor node.

Moreover, each of the sensor nodes generates the list of the uplink neighbors during the setting time, and after the corresponding sensor node first receives the control message, when a setting time elapses, it transmits to the sink node the information on the list of the uplink neighbors of each sensor node, including a reply message of the control message. Herein, the reply message is a network initialization reply message that includes at least one of a sequence number of the control message received by the corresponding sink node, a hop count from the corresponding sensor node to the sink node, an address of the corresponding sensor node, and the number of uplink neighbors of the corresponding sensor node, and an address of each uplink neighbor.

Meanwhile, the searching the route includes searching at least one uplink route by setting a directional graph from the routing table and selecting the uplink neighbor of each sensor node from the designation node using the set directional graph; and searching a downlink route by taking a reverse route of the searched uplink route.

Further, the searching the route searches a route based on the uplink neighbor having higher priority by discriminating the priority for the uplink neighbor of each sensor node and the priority for the uplink neighbor is high as the search sequence among the uplink neighbors is fast and the number of uplink neighbors connected to the uplink neighbor of the corresponding sensor node is small when the search sequence is the same.

Also, in the transmitting the data packet, the sink node includes the route source searched up to the designation node in the data packet and transmits the data packet to the designation node through the corresponding sensor node along the route source included in the data packet.

Also, the multi-path source routing method in the sensor network according to the present invention further comprises allowing the sensor node to select an optional uplink neighbor based on the list of the uplink neighbors stored in the corresponding sensor node and transmits the data packet to the sink node through the selected uplink neighbor.

On the other hand, in order to achieve the above object, there is provided a multi-path source routing method in a sensor network according to the present invention comprising: allowing the sink node to search a route from a registered routing table to a designation node based on information on an uplink neighbor of each sensor node and transmit a data packet; allowing the sink node to receive an error message generated from an intermediated node in the case where a route from the intermediate node to another sensor node is disconnected when the data packet is transmitted to the designation node; allowing the sink node to determine a route after being disconnected from an error message received from the intermediate node and re-search from the routing table a route of another sensor node that has the intermediate node as the uplink neighbor; and allowing the sink node to transmit the re-searched route source to the intermediate node and transmit the data packet to the designation node along the route source reset by the intermediate node.

The error message is a node error message that includes at least one of a route request flag set by the intermediate node, an address of the intermediate node generating the error message, an address of an unreachable node due to the route disconnection, and an address of an unreachable designation due to the route disconnection.

In the re-searching, when there is no other sensor node having the intermediate node as the uplink neighbor, the sink node searches another route to the designation node and retransmits the data packet. Meanwhile, the intermediate node discards the data packet received from the sink node when there is no reply of the error message from the sink node for a predetermined time.

In order to achieve the above objects, there is provided a multi-path source routing method comprising: allowing the sensor node to select an uplink neighbor registered in the corresponding sensor node and transmits the data packet to the sink node; when a route from an intermediate node to the uplink neighbor is disconnected during transmitting a data packet to the sink node, allowing the intermediate node to select another uplink neighbor, transmit the data packet to the sink node, and transmits an uplink route request message to the neighbor node when there is no another uplink neighbor; and when a reply message for the uplink route request message from the neighbor node is received, allowing the intermediate node to reset the neighbor node as the uplink neighbor and transmit the data packet to the sink node through the reset uplink neighbor.

The reply message is an uplink route reply message that includes at least one of an address of a neighbor node generating a reply message for the control message and a hop count from the neighbor node to the sink node. At this time, the intermediate node sets a neighbor node transmitting the reply message having a small number of hop counts among the neighbor nodes transmitting the reply message to the uplink neighbor.

Also, when transmitting the data packet through the newly set uplink neighbor, the intermediated node transmits information on the newly set uplink neighbor to the sink node and updates a routing table registered in the sink node.

The present invention can generate the multi-path to each sensor node so as to maintain the uplink neighbor for transmitting the data from each sensor node to the sink node using the network initialization process and to increase the fault tolerant by obtaining information from the sink node.

Further, the present invention reduces the control message overhead while using the multi-path and reduces the routing table size in the sensor node to increases the scalability and the energy efficiency regardless of the size of the network.

Also, the present invention transmits the data by using the tree-based multi-path source routing method that proposes the scalability, fault tolerant, and simplification of optimal route setting and implementation of the network, which are the main problems of the sensor network, such that there is no a need to maintain a route to another sensor node other than the sink node in each sensor node, and as result, less memory is used. Also, the present invention provides a method for properly recovering a disconnected route, thereby facilitating the maintenance and management of the sensor network.

### BRIEF DESCRIPTION OF THE DRAWINGS

FIG. 1 is a system configuration diagram of a sensor network according to the present invention;

FIGS. 2A and 2B are diagrams exemplifying a search of an uplink route and a downlink route in a sensor network;

FIGS. 3A and 3B are structure diagrams of a message transmitted for initialization of a sensor network;

FIG. 4 is an algorithm for generating a list of uplink neighbors in a sensor node according to the present invention;

FIGS. 5A and 5B are flow charts showing an operation flow of FIG. 4;

FIG. 6 is a diagram showing a routing table of a sink node according to the present invention;

FIGS. 7A and 7B are diagrams exemplifying a setting of an uplink route and a downlink route in a sensor network according to the present invention;

FIGS. 8A to 8C are diagrams exemplified to explain an operation of a method for recovering a disconnected route in a sensor network;

FIGS. 9A and 9B are structure diagrams of a message transmitted for recovering a route in a sensor node according to the present invention; and

FIGS. 10A and 10B are structure diagrams of an error message transmitted when a route is disconnected in a sensor network according to the present invention.

### DESCRIPTION OF THE PREFERRED EMBODIMENTS

Hereinafter, exemplary embodiments of the present invention will be described with reference to the accompanying drawings.

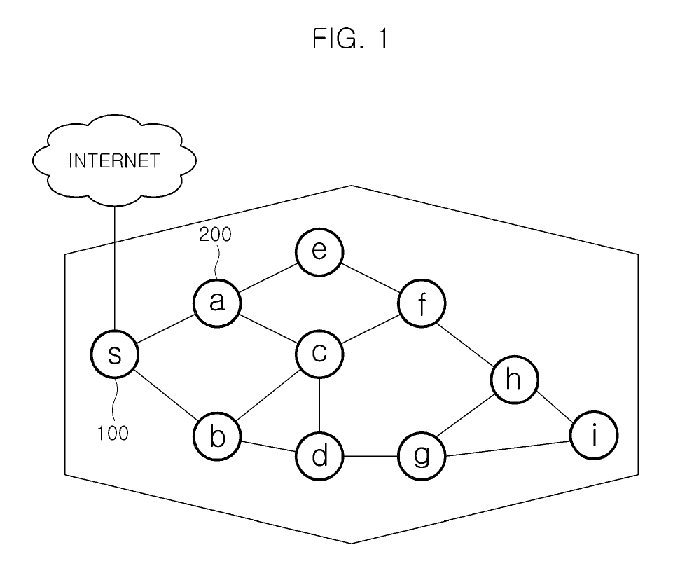

FIG. 1 is a system configuration diagram of a sensor network to which the present invention is applied. As shown in FIG. 1, a sensor network system according to the present invention includes: a plurality of sensor nodes a to i that have a sensor and collect predetermined data on the sensor network system; and a sink node (S) 100 that receives the data collected through the plurality of sensor nodes a to I and processes the necessary information. The sensor network is provided with the plurality of sensor nodes a to i for monitoring a generally wide sensor field. At this time, the plurality of sensor nodes a to i are intensively disposed to continue a function of the network even if a small number of sensor nodes are in an inoperable state due to causes, such as battery exhaustion, etc. Therefore, most sensor nodes 200 have one or more uplink neighbor, but almost all sensor nodes have two or more uplink neighbors.

Herein, the sensor node 200 is disposed in a sensor field without mobility or at a speed lower than 1 m/s to collect an interest data. At this time, the sensor node 200 transmits the collected data to the sink node 100. Further, each sensor node 200 has only one identifier in the sensor network. In the embodiment of the present invention, for convenience of explanation, assume that each sensor node includes a node identifier having a 16-bit size.

On the other hand, the sink node 100 frequently monitors the data collected through each sensor node 200 and determines whether a specific event is generated. If a specific event is generated, the sink node 100 instructs the corresponding sensor node 200 to perform an appropriate operation according to an attribute of the event or notify a manager, which manages the network, of the event generation. Herein, there is generally one sink node 100 in the one sensor network.

In the present invention, a method for routing a scalable multi-path source suitable for the sensor network system will be described. At this time, the method for routing a multi-path source formed between the sink node 100 and each sensor node 200 will be described by sorting a network initialization process, an uplink/downlink data transferring process, and a network maintaining and managing process.

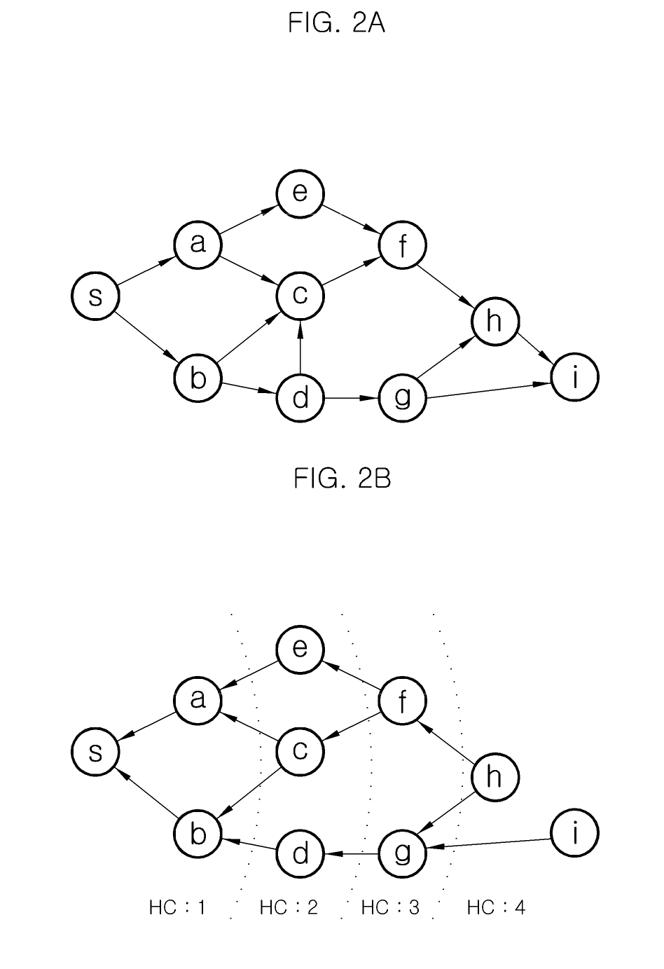

FIGS. 2A and 2B are diagrams exemplifying a description of a network initializing process in a sensor network. The method for setting a route of a wireless sensor network according to the present invention performs the network initialization process by using a scalable multi-path source routing (hereinafter, referred to as ‘SMSR’) protocol to form the multi-path without overlapping nodes between the sink node 100 and the sensor node 200, without exchanging a further control message only by the control message exchange, and to perform communication by setting a gradient route to the sink node 100 in the sensor node 200.

FIG. 2A is a diagram showing an operation transmitting to each sensor node by allowing the sink node to generate the initialization request message.

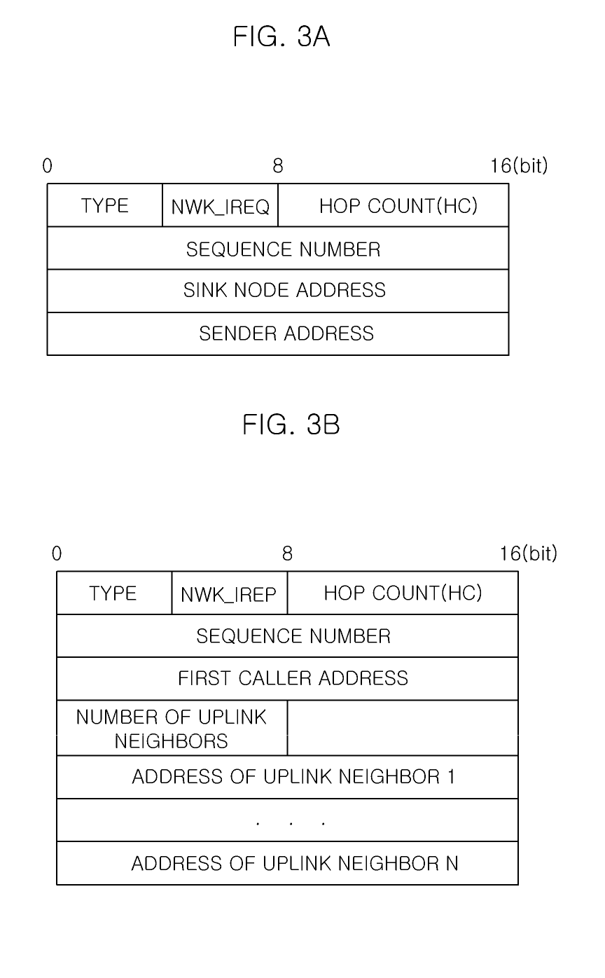

The network initialization process, which is a process that is necessarily undergone for setting the route in the SMSR, starts by allowing the sink node 100 to generate the network initialization request message (hereinafter, referred to as ‘NWK_IREQ’) and transmitting the network initialization request message to each sensor node 200, as shown in FIG. 2A. At this time, the NWQ_IREQ includes a sequence number of a message and information on a hop count from the sink node 100 in order to prevent a routing loop from being generated. The detailed structure of the NWK_IREQ will be described with reference to FIG. 3A.

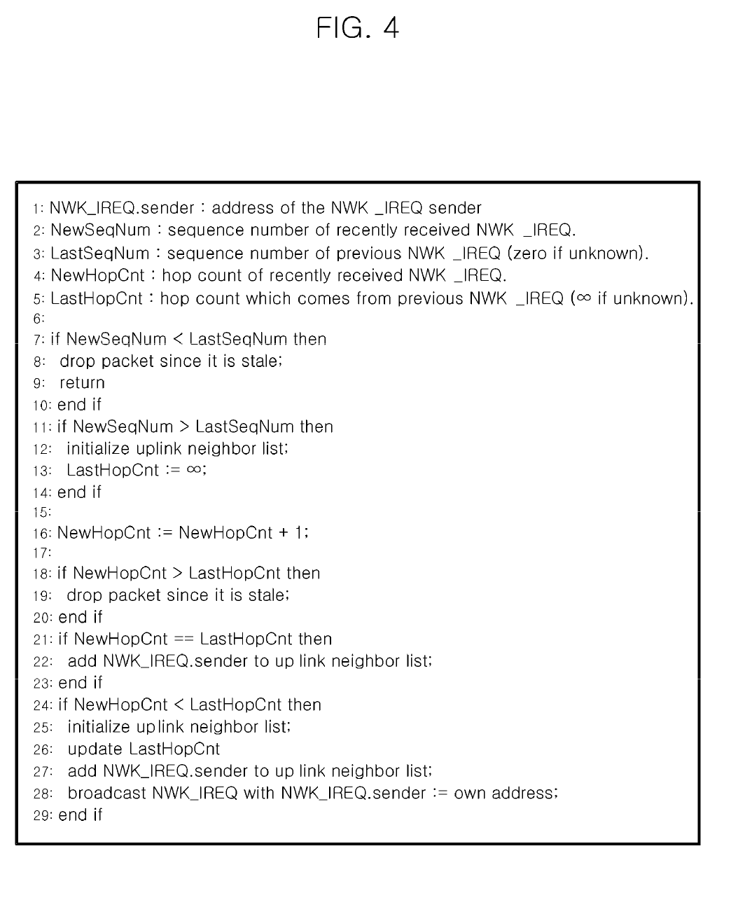

Each sensor node 200 continues to receive the NWK_IREQ for a predetermined time, that is, INIT_LISTEN_DURATION from after receiving the earliest NWK_IREQ from the sink node 100 or another sensor node to collect the information on the neighbor node in order to obtain information on a plurality of uplink routes that reach the sink node 100. The list of the uplink neighbors of the corresponding sensor node 200 is made based on the information. At this time, the sensor node 200 processes the received NWK_IREQ according to an algorithm of FIG. 4 to initialize the list of the uplink neighbors of the network and make a new list of uplink neighbors. Therefore, the sensor node 200 selects the neighbor nodes having the smallest number of hop counts to the sink node among the information on the collected neighbor nodes as its own uplink neighbor, making it possible to maintain a plurality of uplink routes without forming a loop that reaches the sink node 100.

Herein, the INIT_LISTEN_DURATION is a standby time that receives the network initialization message transmitted by the neighbor node after the sensor node 200 receives the NWK_IREQ having the new sequence number. When the sink node 100 transmits the NWK_IREQ to each sensor node 200, it gives and distributes an appropriate jitter. At this time, the sink node 100 sets the INIT_LISTEN_DURATION to a multiplication or more of the expected maximum hop counts by the maximum jitter value. If the INIT_LISTEN_DURATION elapses, the corresponding sensor node 200 includes its own hop counts and the information on the list of the uplink neighbors to generate the network initialization reply message (hereinafter, referred to as ‘NWK_IREP’) and replies to the NWK_IREQ by transmitting the NWK_IREP to the sink node 100 as shown in FIG. 2B. Herein, a message structure of the NWK_IREP will be described with reference to FIG. 3B.

At this time, when the sensor node 200 transmits the NWK_IREP to the sink node 100, it optionally selects and transmits any one of the list of the uplink neighbors of the corresponding sensor node 200.

Meanwhile, the sink node 100 sets the INIT_DURATION, which is a standby time for receiving the NWK_IREP, according to the size of the network. At this time, each sensor node 200 distributes the NWK_IREP during the INIT_DURATION and transmits it to the sink node 100.

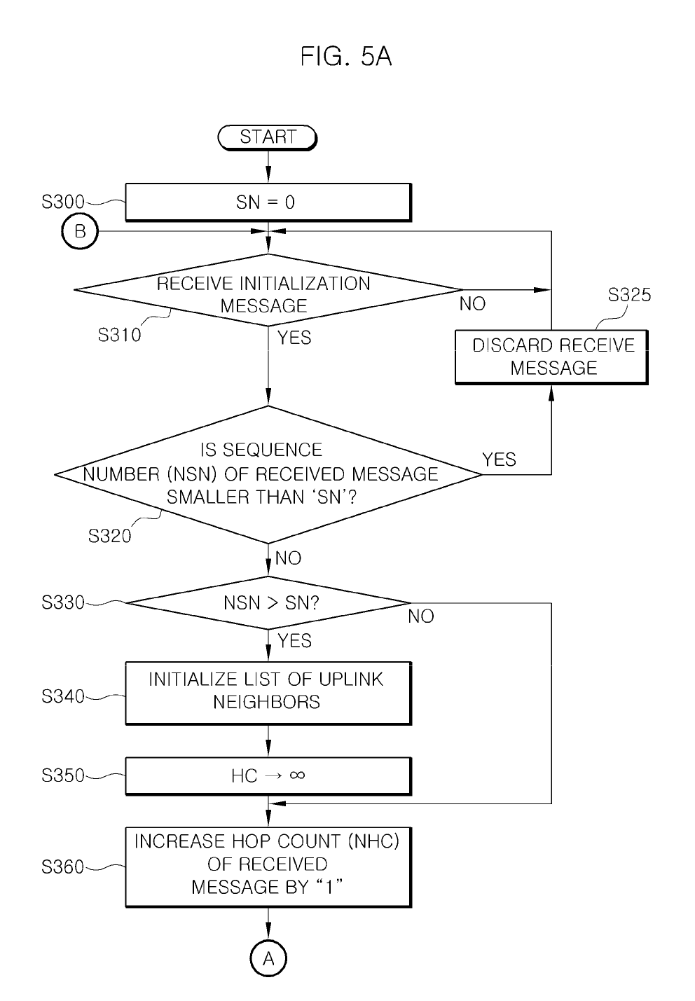

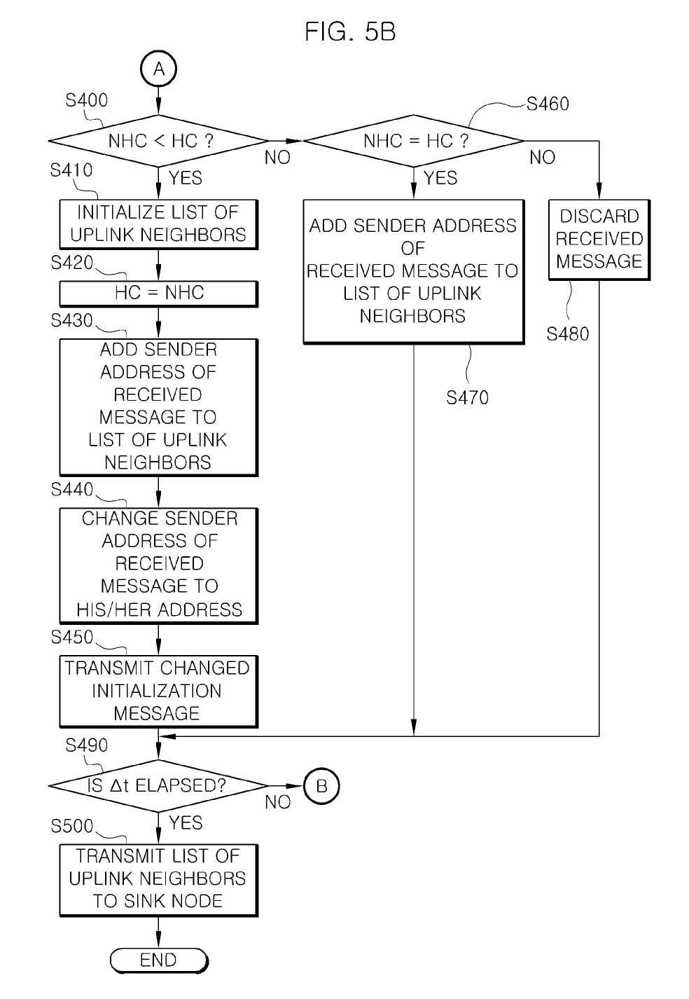

Therefore, the sink node 100 waits to receive the NWK_IREP transmitted by each sensor node 200 during the INIT_DURATION from after broadcasting the NWK_IREQ. The sink node 100 generates the routing table based on the received NWK_IREP only when the sequence number of the NWK_IREP is the same as the sequence number of the latest NWK_IREQ transmitted by the sink node if the NWK_IREP is reached. Herein, the detailed embodiment of the routing table will be described with reference to FIG. 5.

FIG. 3A is a diagram showing a message structure of the NWK_IREQ according to one embodiment of the present invention and FIG. 3B is a diagram showing a message structure of the NWK_IREP according to one embodiment of the present invention.

First, the message structure of the NWK_IREQ will be described with FIG. 3A. The NWK_IREQ includes a type field that defines a message type, a hop count field having a 8-bit size that stores the number of hops transmitting the NWK_IREQ from the sink node 100 to the corresponding sensor node 200, a 16-bit integral number type sequence number field without a sign that plays a role of determining which message is more recently generated when receiving the NWK_IREQ several times, a sink node address field, and an NWK_IREQ sender address field of the hop just before the NWK_IREQ is transmitted to the corresponding sensor node 200.

The sink node 100 sets its own sequence number and the sink node address and the hop count to ‘0’ when generating the NWK_IREQ. Finally, the sink node sets the sender address transmitting the NWK_IREQ to its own address and then sends out it to the network. Herein, after the sequence number starts from ‘1’ when generating the NWK_IREQ, when generating a new NWK_IREQ, the sequence number increases by ‘1’. If the sequence number exceeds sizes (65, 535) that can be represented by 16 bits, it returns to ‘1’.

On the other hand, the message structure of the NWK_IREP will be described with reference to FIG. 3B. The NWK_IREP includes a type field that defines a message type, a hop count field having a 8-bit size that stores the hop count transmitting the NWK_IREQ from the corresponding sensor node 200 to the sensor node 100, a 16-bit size integral number type sequence number field without a sign that stores the sequence number of the latest received NWK_IREQ, a sink node address field, and a first NWK_IREP originator address field that stores the address of the sensor node 200 generating the NWK_IREP, the number of uplink neighbor fields having an 8-bit size that stores the number of uplink neighbors of the corresponding sensor node 200, and each uplink neighbor address field.

FIG. 4 is a diagram showing an algorithm referenced to allow the sensor node according to one embodiment of the present invention to perform the network initialization process from the NWK_IREQ.

In the algorithm of FIG. 4, variables, such as ‘NWK_IREQ. Sender’, ‘NewSeqNum’, ‘LastSeqNum’, ‘NewHopCnt’, and ‘LastHopCnt’ are used, wherein the ‘NWK_IREQ. Sender’ is a variable showing an address value of a sender transmitting the NWK_IREQ to the corresponding sensor node 200, the ‘NewSeqNum’ is a variable showing the sequence number of the currently received NWK_IREQ, and the ‘LastSeqNum’ is a variable showing the sequence number of the previously received NWK_IREQ. At this time, an initial value of the ‘LastSeqNum’ is ‘0’. Further, the ‘NewHopCnt’ is a variable showing the hop count of the currently received NWK_IREQ and the ‘LastHopCnt’ is a variable showing the hop count of the previously received NWK_IREQ. At this time, an initial value of the ‘LastHopCnt’ is ‘∞’.

Herein, the algorithm process of FIG. 4 will be described in detail with reference to FIGS. 5A and 5B and therefore, the description of the algorithm process of FIG. 4 will be omitted.

FIG. 5A is a flow chart showing a process of an algorithm of column 7 to column 16 of FIG. 4. FIG. 5B is a flow chart showing a process of an algorithm of column 18 to column 29 of FIG. 4. At this time, in FIGS. 5A and 5B, for convenience of explanation, the algorithm will be described by replacing the “NewSeqNum” by a ‘NSN’, replacing the ‘LastSeqNum’ by ‘NHC’, and replacing the ‘LastHopCnt’ by ‘HC’.

First, FIG. 5A shows a process of initializing the list of the uplink neighbors when the sensor node receives the NWK_IREQ having the latest sequence number. In other words, in the state of SN=0 (S300), if the initialization message, that is, the NEW IPEQ is received (S310), the corresponding sensor node 200 senses the sequence number (NSN) of the received message to compare it with ‘SN’ (S320 and S330). Herein, when the sink node 100 first generates the NWK_IREQ, since the sequence number is set from ‘1’, the sensor node 200 allows an initially received NWK_IREQ to have a sequence number of ‘1’. At this time, since SN=0, the ‘NSN’ has a value larger than the ‘SN’.

Therefore, the corresponding sensor node 200 initializes the list of the uplink neighbors (S340). The sensor node 200 after the ‘S340’ process sets SN=NSN and HC=∞ (S350) and after increasing the hop count of the received message to ‘1’ (S360), a process of FIG. 5b is performed. At this time, in the ‘S350’ process, when the SN value updated into the NSN receives another NWK_IREQ later, the ‘S320’ and ‘S330’ processes are applied.

Of course, while a process of FIG. 5A is performed on the subsequently received NWK_IREQ, the sequence number of the newly received message and the previously received message are compared and when the sequence number of the newly received message has a sequence number lower than the previously received message, the corresponding sensor node 200 discards the newly received message (S325). Further, the sequence number of the newly received message has a sequence number higher than the previously received message (S330), the corresponding sensor node 200 initializes the list of the uplink neighbors (S340) and sets SN=HSN and HC=∞ (S350). Meanwhile, when the sequence number of the newly received message is the same as that of the previously received message, the ‘S340’ and ‘S350’ processes are omitted.

FIG. 5B shows a process of updating the list of the uplink neighbors according to the hop counter of the received NWK_IREQ.

The sensor node 200 performing a process of FIG. 5A compares ‘NHC’ with ‘HC’ that are the hop count of the received message (S400 and S460). At this time, in the ‘S350’ process of FIG. 5A, since HC=∞, the ‘NHC’ has a value lower than the ‘HC’.

Therefore, the corresponding sensor node 200 initializes the list of the uplink neighbors (S410) and sets HC=NHC, and, updates the ‘HC’ into the value of the ‘NHC’ (S420). Thereafter, when the HC updated in the ‘S420’ process receives another NWK_IREQ, the ‘S400’ and ‘S460’ processes are applied.

At this time, the corresponding sensor node 200 adds the sender address of the received message to the list of the uplink neighbors (S430) and the sender address of the received message is changed to its own address and is then transmitted to the neighbor node (S440 and S450).

Of course, while a process of FIG. 5b is performed on the subsequently received NWK_IREQ, comparisons of the hop counts of the newly received message with the previously received message is performed and when the hop count of the newly received message is lower than that of the previously received message, the corresponding sensor node 200 performs the ‘S410’ to ‘S450’ processes once again.

If the hop counts of the newly received message and the previously received message are the same (S460), the corresponding sensor node 200 adds the sender address of the received message to the list of the uplink neighbors (S470). Further, when the hop count of the newly received message is higher than the previous hop count of the previously received message, the corresponding sensor node 200 discards the newly received message (S480).

On the other hand, the corresponding sensor node 200 counts a time from a point in time first receiving the NWK_IREQ, receives the NWK_IREQ from the neighbor node until a predetermined time (Δt) elapses, and updates the list of the uplink neighbors and after the predetermined time (Δt) elapses (S490), the sensor node 200 generates the NWK_IREP including the lowest hop count and the list of the uplink neighbors up to the sink node 100 and transmits it (NWP_IREP??) to the sink node 100 (S500).

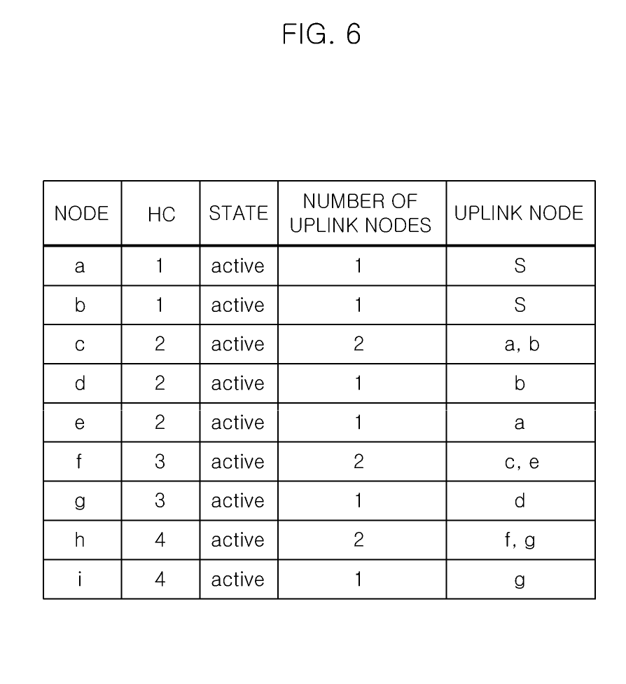

FIG. 6 is a diagram showing a routing table generated from the NWK_IREP that is received from the sensor node by the sink node after initializing the network according to one embodiment of the present invention. At this time, the routing table of FIG. 6 is a routing table completed by referring to FIG. 2B.

The sink node ‘S’ senses the hop count of each sensor node 200 from the NEW_IREP that is received from a plurality of sensor nodes ‘a’ to ‘i’, the number of uplink neighbors, and the address information on the uplink neighbors and completes and stores the routing table shown in FIG. 6. In other words, ‘a’ has the hop count of ‘1’ between the sink nodes ‘S’ and the sink node ‘S’ as the uplink neighbor. Likewise, ‘b’ has the hop count of ‘1’ between the sink nodes ‘S’ and the sink node ‘S’ as the uplink neighbor.

Meanwhile, ‘c’ has the hop count of ‘2’ between the sink nodes ‘S’ and ‘a’ and ‘b’ as the uplink neighbor. Further, ‘d’ has the hop count of ‘2’ between the sink nodes ‘S’ and ‘b’ as the uplink neighbor. Also, ‘e’ has the hop count of ‘2’ between the sink nodes ‘S’ and ‘a’ as the uplink neighbor.

On the other hand, ‘f’ has the hop count of ‘3’ between the sink nodes ‘S’ and ‘c’ and ‘e’ as the uplink neighbor. Further, ‘g’ has the hop count of ‘3’ between the sink nodes ‘S’ and ‘d’ as the uplink neighbor. Meanwhile, ‘h’ has the hop count of ‘4’ between the sink nodes ‘S’ and ‘f’ and ‘g’ as the uplink neighbor. Also, ‘i’ has the hop count of ‘4’ between the sink nodes ‘S’ and ‘g’ as the uplink neighbor.

At this time, the sink node 100 can cause the loss of the NWK-IREP message if a problem such as an unstable wireless link, etc occurs. At this time, the sink node 100 wholly retrieves the routing table to find the sensor node 200 that exists in the list of the uplink neighbors but does not exist in the routing table entry, making it possible to confirm the sensor node 200 that does not received the NWK_IREP.

When the NWK_IREP loss is sensed, the downlink route to the sensor node 200 that has the NWK_IREP loss node as the uplink neighbor is calculated and the address of the NWK_IREP loss node is added to the downlink route to transmit the NWK_IREP retransmission request message (NWK_IREP_RETRANS_REQ). Therefore, the NWK_IREP loss node retransmits the NWK_IREP to the sink node 100 through the downlink route and the sink node 100 reconfigures the routing table based on the newly received NWK_IREP from the NWK_IREP loss node.

Meanwhile, when the downlink route to the sensor node 200 having the NWK_IREP loss node as the uplink neighbor is not found, the sink node 100 uses, as an effective hop count, the hop count by 1 lower than the hop count of the sensor node having the NWK_IREP loss node as the uplink neighbor to transmit the NWK_IREP retransmission request message (NWK_IREP_RETRANS_REQ), thereby trying the route search to the NWK_IREP loss node.

Thereby, each sensor node 200 does not need to maintain the routing table and when the route disconnection is disconnected by the fault of each sensor node 200, the route recovering method having little control message overhead by using the routing table that is stored in the sink node 100 is provided.

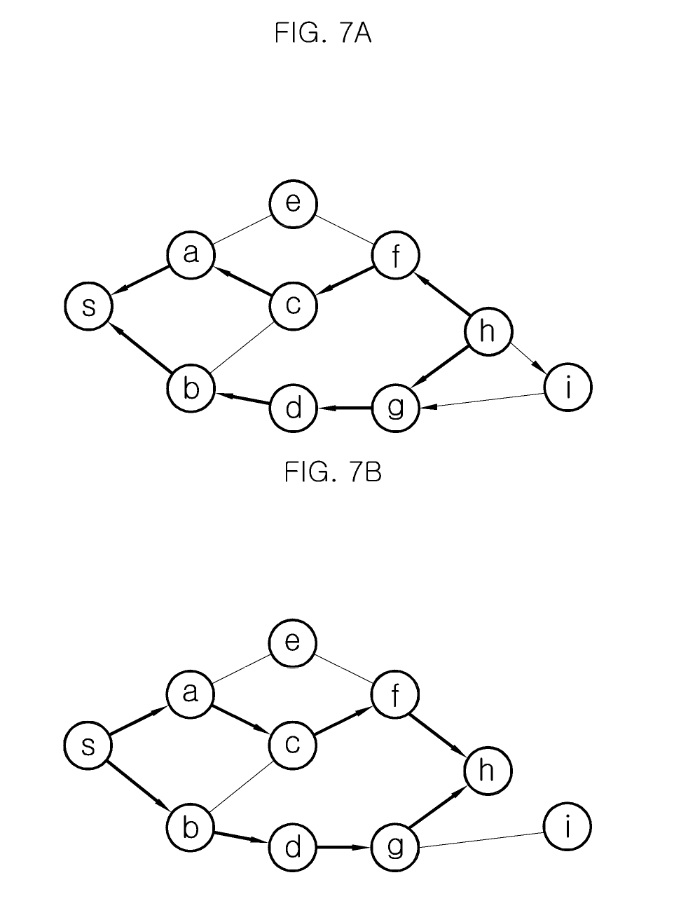

FIGS. 7A and 7B show a process of calculating the route by allowing the sink node to use the routing table in order to transmit the data packet within the sensor network.

The sink node 100 schematizes the routing table for setting the route to transmit the data packet using a graph G and searches the graph G to calculate the route between each sensor node 200. Herein, the graph G is configured of ‘V’ that is a set of one or more advantage and ‘E’ that is a set of connecting lines formed in a pair of two apexes, such that it is represented by G=(V, E). At this time, the graph G is a non-circulation direction graph.

At this time, the route from the sink node 100 to the sensor node 200, that is, the downlink route is a route obtained by searching ‘G’ from the designation sensor node 200 to the sink node 100. That is, the downlink route can be obtained by reversely taking the uplink route. In the network initialization process according to the algorithm of FIG. 4, since each sensor node 200 selects only the uplink neighbors having the shortest distance to the sink node 100, the route obtained by the above process always has the shortest route to the sink node 100.

Meanwhile, when the sink node 100 searches the multi-path from the graph G, it uses an algorithm that modifies a breadth-first search (BFS). This algorithm uses a priority queue that uses the search sequence and the number of the uplink neighbors as an aligning reference instead of using the queue in the breadth-first search. In this priority queue, as the search sequence is fast, the priority is high and when the search sequence is the same, the node having the small number of uplinks has the high priority. In other words, instead of developing each uplink neighbor in a searched order, a sufficient number of multi-paths can be found by first extending the sensor node 200 having a small number of selectable uplink neighbors.

As shown in FIG. 7A, the sink node uses the designation node as ‘h’ and searches the uplink neighbor of ‘h’. At this time, the sink node selects ‘g’ among ‘f’ and ‘g’, which are the uplink neighbors of ‘h’, according to the priority and selects ‘d’ that is a unique uplink neighbor of ‘g’ to a next route. Further, the sink node selects ‘b’ that is a unique uplink neighbor of ‘d’ to a next route and selects one uplink route such as ‘h→g→d→b→S’ by selecting the sink node ‘S’ that is the uplink neighbor of ‘b’.

Meanwhile, the sink node 100 selects ‘f’, which is not selected, among the uplink neighbors of ‘h’. Next, the sink node selects a node having a high priority among ‘c’ and ‘e’ that are the uplink neighbors of ‘f’. If ‘c’ has a high priority, the sink node selects ‘c’ to a next route and subsequently, selects ‘a’ that is not selected in the previously searched uplink route among ‘a’ and ‘b’ that are the uplink neighbors of ‘c’. Finally, the uplink node 100, which is the uplink neighbor of ‘a’, is selected, thereby searching another uplink route such as ‘h→f→c→a→S’.

If the uplink route searched in FIG. 7A is ‘h→g→d→b→S’ and ‘h→f→c→a→S’, as shown in FIG. 7B, the sink node 100 calculates a reverse route of the uplink route, thereby obtain the downlink route. Therefore, the downlink route from the sink node ‘S’ to ‘h’ is ‘S→b→d→g→h’ and ‘S→a→c→f→h’. By such a method, the sink node 100 can search multi-paths, which do not overlap, based on the routing table.

The sink node 100 transmits the packet of the above-mentioned set downlink route in a form of a source route to ‘h’, which is the designation node, by including it in the packet. Therefore, since the sensor node 200 receiving the packet transmitted by the sink node 100 stores the overall route information in the packet, even if the route information is not stored in each sensor node 200, it cannot be appreciated whether the packet is transmitted to any neighbor node from each packet and since the sensor node 200 itself does not calculate the route using geographical information, the loop does not occur.

The foregoing description shows a downlink search process to transmit the data packet to the sensor node 200.

On the other hand, the uplink route search to allow the sensor node 200 to transmit the data packet to the sink node 100 can transfer the packet to the sink node 100 through the uplink route made in the above-mentioned network initialization process. At this time, the uplink route transfers the data packet to the sink node 100 using a method of selecting any uplink neighbor in the list of the uplink neighbors that is maintained by each sensor node 200. At this time, a method of selecting the uplink neighbor is as follows.

Each sensor node 200 gives a priority value to the uplink neighbor obtained in the network initialization process. As one example, the initial priority value of the uplink neighbor is set to 100. At this time, when the data transmission from the sensor node 200 to the uplink neighbor succeeds, the priority value of the uplink neighbor increases to 50 and can increase to 200 maximally. Meanwhile, when the data transmission from the sensor node 200 to the uplink neighbor fails, the priority value of the uplink neighbor reduces to 50. If the priority value is 50, the sensor node 200 is represented as an unusable state for the corresponding uplink neighbor.

At this time, the uplink neighbor set of the corresponding sensor node 200 is represented by U_{N} and the priority value of u, which is u ∈ U_{N} is represented by P(u) Herein, any one value P_{S} of the values that sums all the priority values of each uplink neighbor from 1 is selected and P(u), which is the priority value, is subtracted from P_{S} in an order of the uplink neighbor such that the uplink neighbor is selected when a value of 0 or more is firstly generated.

In other words, assume that when the uplink neighbor of ‘f’ is ‘c’ and ‘e’, P(c), which is a priority value of ‘c’, is ‘100’ and P(e), which is a priority value of ‘e’, is ‘50’ by failing the data transmission once. At this time, if any number ‘25’ among a value from 1 to 150 (a value summing the priority values of ‘a’ and ‘c’) is selected, the calculation of [{P_{S}−P(c)}−P(e)] is performed. Herein, since it is assumed that ‘c’ and ‘e’ are recorded in the list of the uplink neighbors of f in order, P(c) is first subtracted from P_{S}. Therefore, since P_{S}−P(c)=25−100=−75 is lower than 0, f selects c. If 125 is selected as P_{S}, since {P_{S}−P(c)}−P(e)=(125−100)−50=−25 is lower than 0 after subtracting P(e) using, ‘f’ selects ‘e’.

Of course, the method of selecting an uplink neighbor is only one example and the method of selecting any node in the list of the uplink neighbors can be variously applied.

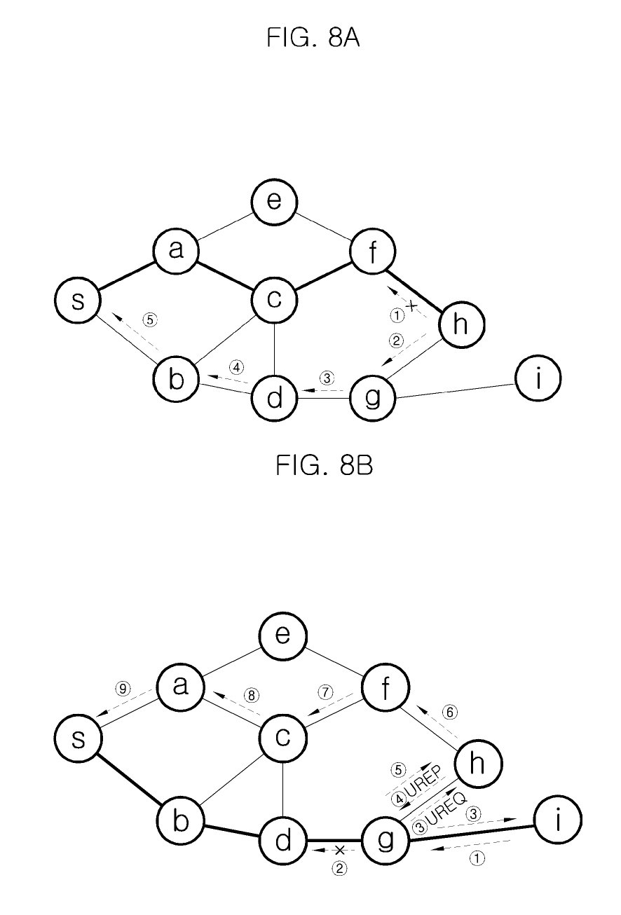

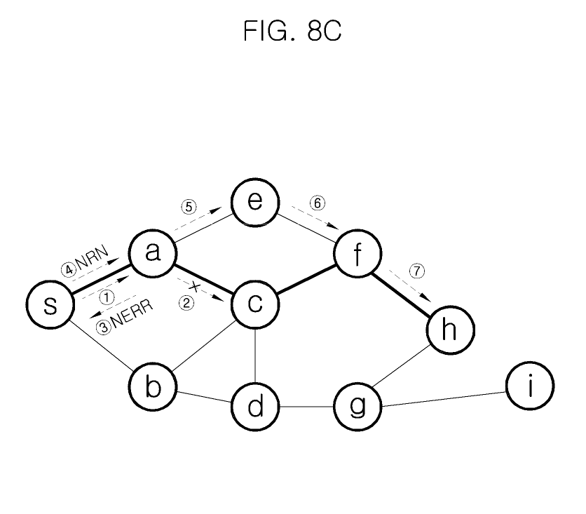

FIGS. 8A to FIG. 10B relate to the network maintaining and managing process and in the process of transferring the data packet between the sink node 100 and the sensor node 200 using the above-mentioned uplink route or the downlink route, when the route disconnection occurs, the process of recovering the disconnected route is shown.

First, FIGS. 8A and 8B show the process of recovering the uplink route when the uplink route is disconnected. FIG. 8A is a diagram showing a case where the route to one uplink neighbor is disconnected when there are two or more uplink neighbors and FIG. 8B is a diagram showing a case where the route is disconnected when there is one uplink neighbor.

FIG. 8A shows a case where the route of h→f is disconnected, wherein ‘h’ transmits the data packet using the uplink route such as h→f→c→a→S. At this time, ‘h’ selects ‘g’ that is another uplink neighbor to transmit the data packet. At this time, ‘g’ selects ‘d’ that is a unique uplink neighbor to transmit the data packet. Likewise, ‘d’ selects ‘b’ that is a unique uplink neighbor to transmit the data packet. Finally, ‘b’ selects the sink node ‘S’ that is the uplink neighbor, such that ‘h’ transmits the data packet using the uplink route such as h→g→d→b→S. Therefore, even if h→f is disconnected in h→f→c→a→S, ‘h’ selects another uplink neighbor such that the data transfer route is easily and rapidly recovered by transmitting the data packet to the route of h→g→d→b→S.

Meanwhile, FIG. 8B shows a case where the route of g→d is disconnected, wherein ‘i’ transmits the data packet using the uplink route such as i-<g-<d-<b-<S.

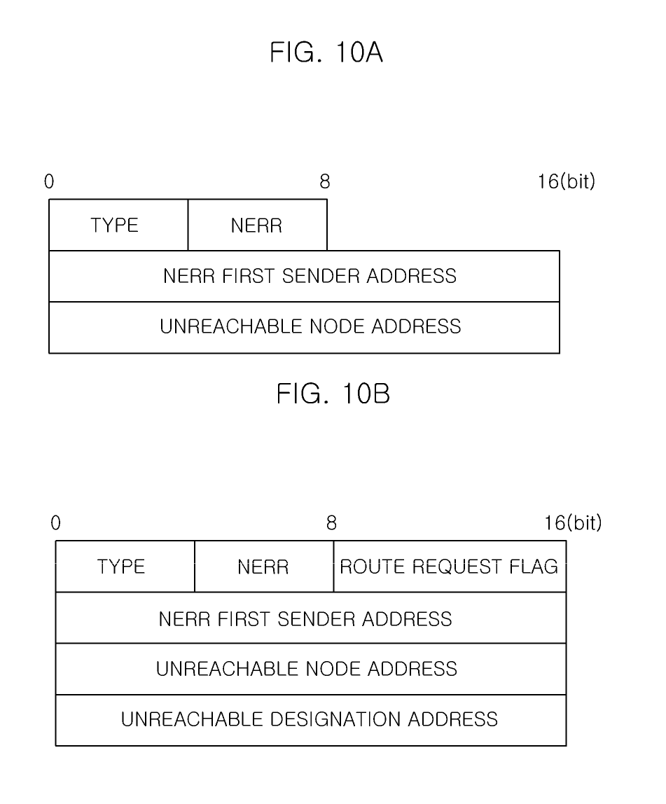

In other words, ‘i’ selects ‘g’ that is a unique uplink neighbor to transmit the data packet. Likewise, ‘g’ selects ‘d’ that is a unique uplink neighbor to transmit the data packet. If the data transmission to ‘d’ fails, ‘g’ reduces the priority of ‘d’ in the list of the uplink neighbors. At this time, if the data transmission to ‘d’ continuously fails, ‘g’ is considered as an unusable node when the data transfer route to ‘d’ that is the uplink neighbor is disconnected, such that a node error message (hereinafter, referred to as ‘NERR’) for ‘d’ is generated and is transmitted to the sink node ‘S’. At this time, the structure of the NERR generated when transmitting data using the uplink route will be described with reference to FIG. 10A.

Meanwhile, ‘g’ sends out an uplink route request (hereinafter, referred to as ‘UREQ’) to the neighbor node to generate a new uplink route. Unlike the NWK_IREQ, the UREQ is not broadcasted to the whole network and is sent out within a range of one hop.

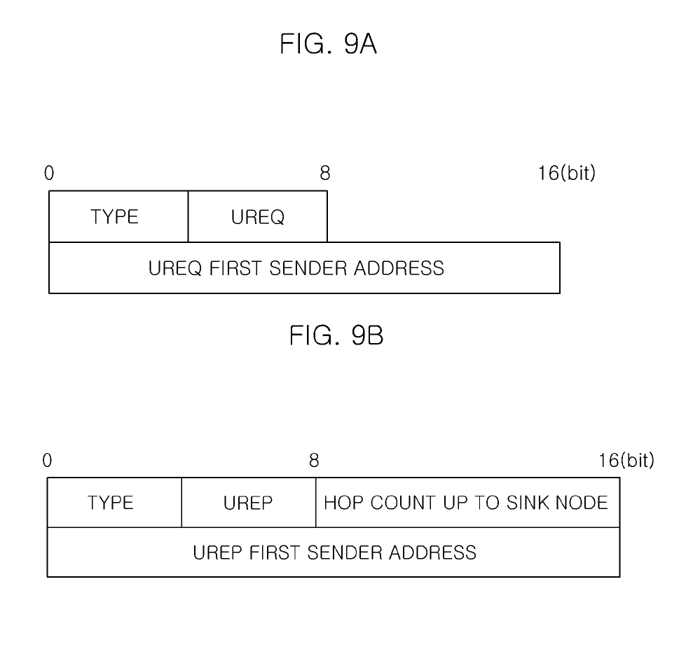

At this time, as in the network initialization process, ‘g’ waits for an uplink route reply (hereinafter, referred to as ‘UREP’) of the neighbor node during the INIT_LISTEN_DURATION. Herein, the detailed structure of the message for the UREQ and the UREP will be described with reference to FIGS. 9A and 9B.

When ‘g’ receives the UREP from the neighbor node, the list of the uplink neighbors is updated by subjecting to the same process as a case of receiving the NWK_IREQ except when checking the sequence number.

In other words, ‘g’ stores the data packet transmitted from ‘i’ in the transmission queue and transmits the UREQ to ‘h’ and ‘i’ having ‘g’ as the uplink neighbor. At this time, since ‘h’ is another uplink neighbor, it excludes ‘g’ from its own uplink neighbor and transmits the UREP to ‘g’, such that it notifies that the data packet can be transmitted to the sink node 100 through ‘h’. Therefore, ‘g’ receiving the UREF from ‘h’ registers ‘h’ in a new uplink neighbor of ‘g’ and transmits the stored data packet to ‘h’ that is the new uplink neighbor. At this time, ‘g’ is transmitted to the transmission queue of the data packet, including the NERR for the route disconnection of g→d.

Meanwhile, since ‘g’ adds the new uplink neighbor by receiving the UREP, it generates a route recovery notification message (RRN) and transmits it to the sink node 100. Herein, the RRN has the same structure as the NWK_IREP except that the message type is different and there is no the sequence number. At this time, the RRN can be transmitted by being included in the transmission queue of the packet data transmitting the sink node and when the RRN is transmitted, since the sink node 100 can estimate from the change of information that g→d route is disconnected from the uplink neighbor of ‘g’ from the RRN, thus the NERR can be omitted.

Therefore, the data packet transmitted from ‘i’ is transmitted the sink node ‘S’ through the route of i→g→h→f→c→a→S. Of course, the route is only one example and generates the uplink route in ‘i’ again and can transmit the data packet through the route such as i→h→f→c→a→S.

Meanwhile, ‘g’ does not receive the UREP during the INIT_LISTEN_DURATION to maximally perform the process until the uplink route is generated UREQ_MAX_TRY times, for example, when the transmission try to all the uplink neighbors fails as described above. Whenever the process is performed, it is performed by increasing the INIT_LISTEN_DURATION time twice. The communication stops until the process has performed the UREQ_MAX_TRY times when the new uplink route is not generated.

Meanwhile, FIG. 8C shows a process of recovering the downlink route when the downlink route is disconnected.

As shown in FIG. 8C, the sink node ‘S’ uses the route to be s→a→c→f→h to transmit the packet to ‘h’, but when the packet cannot be transmitted by generating the route disconnection between a→c, ‘a’ includes the node address where the route disconnection occurs and the original designation address to the sink node ‘S’ and generates the NERR that notifies the unreachability for ‘c’ and transmits it to the sink node 100. Further, before ‘a’ receives the new route notification (NRN) from the sink node 100, when it receives the packet for transmitting the same designation, it stores the received queue in the queue. In this case, since the NERR is previously transmitted to the sink node 100, the NERR is not transmitted again. If the NRN message is not reached within a specified time from the sink node 100, the packet stored in the queue is discarded. At this time, the NERR structure generated when the data using the downlink route is transmitted will be described with reference to FIG. 10B.

After the sink node 100 receiving the NERR for ‘c’ from ‘a’ cannot temporarily use the unreachable node in its own graph G, the new route to be S→a→e→f→h is searched and transmits it to ‘a’ through the NRN. ‘a’ replaces the source route information of the packet stored in the queue of the NRN transferred from the sink node 100 by a new route and transmits it to ‘e’. Therefore, the data packet transmitted from the sink node 100 is transmitted up to ‘h’, which is the original designation, through the S→a→e→f→h route.

Of course, the sink node 100 uses the S→b→d→g→h route other than S→a→e→f→h route to transmit the data packet. At this time, if the sink node 100 does not transmit the NRN message to ‘a’ that receives the NERR message, a time out is generated in ‘a’, thereby discarding all the packets stored in the queue.

At this time, the sink node 100 transmits an operation confirm request (OC_REQ) to the unreachable node in order to determine whether the unreachable node confirmed by the NERR message is the unreachable case due to an actual inoperable case or the temporal unreachable case due to network congestion. If the corresponding node is normally operated, when the corresponding node receives the OC_REQ from the sink node, it transmits the OC_REP, which is the operation confirm reply message, to the sink node 100. Therefore, the sink node 100 determines that the corresponding node generates the temporal error to update it to the normal route.

Meanwhile, when the sink node 100 does not receive the OC_REP for OC_REQ from the corresponding node, it maximally transmits the OC_REQ MAX_OPERATION_CONFIRMATION_TRY times until the OC_REP is received at an OPERATION_CONFIRM_DURATION period. As a result, when the sink node 100 does not receive the OC_REP for OC_REQ from the corresponding node, it determines that the corresponding node is an inoperable node and records it in the routing table.

FIG. 9A shows the message structure of the UREQ according to the present invention and FIG. 9 shows the message structure of the UREP according to the present invention.

FIRST, the message structure of the UREQ will be described with reference to FIG. 9A.

As shown in FIG. 9A, the UREQ includes a 8-bit size type field that defines the message type and the first UREQ originator address field that stores the address of the sensor node generating the UREQ. Unlike the NWK_IREQ, since the UREQ is transmitted in 1 hop, it does not need the sequence number.

Meanwhile, the message structure of the UREP will be described with reference to FIG. 9B.

As shown in FIG. 9B, the UREP includes an 8-bit size type field that defines the message type, an 8-bit size hop count field that stores the number of hops from the corresponding sensor node 200 to the sink node 100, and a first UREP originator address field that stores the address of the neighbor node generating the UREP. Unlike the NWK_IREP, since the UREQ is transmitted in 1 hop, it does not need the sequence number.

FIGS. 10A and 10B show the message structure of the NERR generated when the data transfer route is disconnected in transmitting the data packet.

First, FIG. 10A is a diagram showing the message structure of the NERR by the uplink route disconnection. The NERR in the uplink route includes an 8-bit size type field that defines the message type, a first NERR originator address field that stores the address of the neighbor node 200 generating the NERR, and an unreachable intermediate node address field that stores the node address where the uplink route is disconnected in the corresponding sensor node 200.

Meanwhile, FIG. 10B is a diagram showing the message structure of the NERR due to the downlink route disconnection. The NERR in the downlink route includes an 8-bit size type field that defines the message type, a route request flag (RRF) that stores a route request flag setting value requesting a new route due to the downlink route disconnection, an unreachable intermediate node address field that stores the node address where the downlink route is disconnected in the corresponding sensor node 200, and an unreachable destination address field that stores an address for the final destination of the data packet that is no longer unreachable by the downlink route disconnection.

In other words, the node that finds the downlink route disconnection stores the data packet, which cannot be reachable any more in the queue and stores the unreachable intermediate node address in the NERR. Further, the corresponding node sets the route request flag and then includes the final designation address, which cannot be reachable any more, in the NERR and transmits it to the sink node 100, such that it notifies that the downlink route is disconnected.

Although the routing method in the wireless sensor network is described, it is not restricted to the configuration and method the embodiments as described above. The embodiments may be variously configured by selectively combining the whole or a part of each embodiment.

What is claimed is:

1. A multi-path source routing method in a sensor network including sink nodes and a plurality of sensor nodes comprising:
allowing the sink node to transmit a control message for initialization to each sensor node and to receive a list of uplink neighbors generated from each sensor node based on information on neighbor nodes obtained from a reply message of the control message;
allowing the sink node to generate a routing table for each sensor node from the list of the uplink neighbors received in the receiving the list of the uplink neighbors;
when the sink node intends to transmit a data packet to a designation node, allowing the sink node to search a route up to the designation node using the routing table; and
transmitting the data packet to the designation node along a route up to the designation node searched in the searching the route.

2. The multi-path source routing method according to claim 1, wherein the control message is a network initialization request message that includes at least one of a sequence number generating the control message, a hop count until the control message is transmitted from the sink node to each sensor node, an address of the sink node, and an address of a neighbor node transmitting the control message.

3. The multi-path source routing method according to claim 2, wherein when generating the list of the uplink neighbors from each sensor node,
if the corresponding sensor node receives at least two control messages, comparing the sequence numbers included in the control message;
wherein the corresponding sensor node sets the neighbor node transmitting the latest control message having a large sequence number to the uplink neighbor to generate the list of the uplink neighbors.

4. The multi-path source routing method according to claim 2, wherein when generating the list of the uplink neighbors from each sensor node,
if the corresponding sensor node receives the control messages from at least two neighbor nodes, comparing the hop counts included in the control message;
wherein the corresponding sensor node sets the neighbor node transmitting the control message having a small number of hop counts to the uplink neighbor to generate the list of the uplink neighbors.

5. The multi-path source routing method according to claim 2, further comprising allowing the corresponding sensor node to change the address of the neighbor node transmitting the control message to its own address, increase the hop count by “1”, and transmits it to another neighbor node.

6. The multi-path source routing method according to claim 3, wherein each of the sensor node generates the list of the uplink neighbors during the setting time,
after the corresponding sensor node first receives the control message, when a setting time elapses, it transmits the information on the list of the uplink neighbors of each sensor node to the sink node, including a reply message of the control message.

7. The multi-path source routing method according to claim 4, wherein each of the sensor node generates the list of the uplink neighbors during the setting time,
after the corresponding sensor node first receives the control message, when a setting time elapses, it transmits the information on the list of the uplink neighbors of each sensor node to the sink node, including a reply message of the control message.

8. The multi-path source routing method according to claim 1, wherein the reply message is a network initialization reply message that includes at least one of a sequence number of the control message received by the corresponding sink node, a hop count from the corresponding sensor node to the sink node, an address of the corresponding sensor node, and the number of uplink neighbors of the corresponding sensor node, and an address of each uplink neighbor.

9. The multi-path source routing method according to claim 1, wherein the searching the route includes:
searching at least one uplink route by setting a directional graph from the routing table and selecting the uplink neighbor of each sensor node from the designation node using the set directional graph; and
searching a downlink route by taking a reverse route of the searched uplink route.

10. The multi-path source routing method according to claim 9, wherein the searching the route searches a route based on the uplink neighbor having higher priority by discriminating priority for the uplink neighbor of each sensor node and wherein the priority for the uplink neighbor is high as the search sequence among the uplink neighbors is fast and the number of uplink neighbors connected to the uplink neighbor of the corresponding sensor node is small when the search sequence is the same.

11. The multi-path source routing method according to claim 1, wherein in the transmitting the data packet, the sink node allows the route source searched up to the designation node to be included in the data packet and transmits the data packet to the designation node through the corresponding sensor node along the route source included in the data packet.

12. The multi-path source routing method according to claim 1, further comprising allowing the sink node to receive the data packet from the sensor node through each uplink neighbor that is optionally selected based on the list of the uplink neighbors stored in the sensor node.

13. A multi-path source routing method in a sensor network including sink nodes and a plurality of sensor nodes comprising:
allowing the sink node to search a route from a registered routing table to a designation node based on information on an uplink neighbor of each sensor node and transmit a data packet;
allowing the sink node to receive an error message generated from an intermediated node in the case where a route from the intermediate node to another sensor node is disconnected when the data packet is transmitted to the designation node;
allowing the sink node to grasp a route disconnected from an error message received from the intermediate node and re-search from the routing table a route of another sensor node that has the intermediate node as the uplink neighbor; and
allowing the sink node to transmit the re-searched route source to the intermediate node and transmit the data packet to the designation node along the route source reset by the intermediate node.

14. The multi-path source routing method according to claim 13, wherein the error message is a node error message that includes at least one of a route request flag set by the intermediate node, an address of the intermediate node generating the error message, an address of an unreachable node due to the route disconnection, and an address of an unreachable designation due to the route disconnection.

15. The multi-path source routing method according to claim 13, wherein in the re-searching, when there is no another sensor node having the intermediate node as the uplink neighbor, further allowing the sink node to search another route to the designation node and retransmit the data packet.

16. The multi-path source routing method according to claim 14, wherein the intermediate node discards the data packet received from the sink node when there is no a reply of an error message from the sink node for a predetermined time.

17. A multi-path source routing method in a sensor network including sink nodes and a plurality of sensor nodes comprising:
allowing the sensor node to select an uplink neighbor registered in the corresponding sensor node and transmit the data packet to the sink node;
when a route from an intermediate node to the uplink neighbor is disconnected during transmitting a data packet to the sink node, allowing the intermediate node to select another uplink neighbor, transmit the data packet to the sink node, and transmit an uplink route request message to the neighbor node when there is no another uplink neighbor; and
when a reply message for the uplink route request message from the neighbor node is received, allowing the intermediate node to reset the neighbor node as the uplink neighbor and transmit the data packet to the sink node through the reset uplink neighbor.

18. The multi-path source routing method according to claim 17, wherein the reply message is an uplink route reply message that includes at least one of an address of a neighbor node generating a reply message for the control message and a hop count from the neighbor node to the sink node.

19. The multi-path source routing method according to claim 18, wherein the intermediate node sets a neighbor node transmitting the reply message having a small number of hop counts among the neighbor nodes transmitting the reply message to the uplink neighbor.

20. The multi-path source routing method according to claim 17, wherein when transmitting the data packet through the newly set uplink neighbor, the intermediated node transmits information on the newly set uplink neighbor to the sink node and updates a routing table registered in the sink node.
